(19) United States
(12) Patent Application Publication
(10) Pub. No.: US 2025/0259174 A1
(43) Pub. Date: Aug. 14, 2025

(54) BLOCK CHAIN-BASED TRANSACTION PROCESSING METHOD AND APPARATUS, DEVICE, AND MEDIUM

(71) Applicant: TENCENT TECHNOLOGY (SHENZHEN) COMPANY LIMITED, Shenzhen (CN)

(72) Inventor: Zhuguang SHAO, Shenzhen (CN)

(21) Appl. No.: 19/197,079

(22) Filed: May 2, 2025

Related U.S. Application Data
(63) Continuation of application No. PCT/CN2023/137386, filed on Dec. 8, 2023.

(30) Foreign Application Priority Data
Apr. 14, 2023 (CN) 202310438018.9

(51) Int. Cl. G06Q 20/40; G06Q 20/38

(52) U.S. Cl. CPC G06Q 20/401; G06Q 20/382

(57) ABSTRACT

A block chain-based transaction processing method includes: determining a smart contract configured for processing a transaction; determining a target resident contract process according to flag values corresponding to resident contract processes recorded in a maintenance array, the maximum number of resident contract processes recorded in the maintenance array being the maximum number of contract processes supported by a docker deployed in a block chain node; replacing, in the maintenance array, the target resident contract process with a target contract process corresponding to the smart contract, and modifying a target flag value corresponding to the target contract process to a first value, the first value characterizing that a corresponding contract process is in an executed state; and transmitting the transaction to the target contract process for processing.

### CROSS-REFERENCES TO RELATED APPLICATIONS

This application is a continuation of PCT Application No. PCT/CN2023/137386, filed on Dec. 8, 2023, which claims priority to Chinese Patent Application No. 2023104380189, filed with the China National Intellectual Property Administration on Apr. 14, 2023 and entitled “BLOCK CHAIN-BASED TRANSACTION PROCESSING METHOD AND APPARATUS, ELECTRONIC DEVICE, AND STORAGE MEDIUM”, the entire contents of all of which are incorporated herein by reference.

### FIELD OF THE TECHNOLOGY

The present disclosure relates to the technical field of block chain, and in particular, to block chain-based transaction processing.

### BACKGROUND OF THE DISCLOSURE

A smart contract is one of core technologies of a block chain. The smart contract is a piece of code having service logic and configured for processing a block chain transaction. The code may be executed in a virtual machine of the block chain. Currently, a virtual machine technology of the block chain has been developing. Especially, with the development of docker technologies, more block chain technologies support the docker as a virtual machine of the smart contract. In this way, a limitation of a smart contract language may be shielded, and smart contracts of various development languages may be supported.

Since the docker technology is isolated from block chain nodes, smart contracts need to be maintained in the docker. However, the docker generally limits resources such as memory. Therefore, a maximum number of supported contract processes is usually configured in the docker to represent the maximum number of contracts executed in parallel in the docker. Under the limit of the maximum number of contract processes, contract processes need to be swapped in/out, i.e., exiting some contract processes, and adding other contract processes.

In some implementations, swapping in/out of the contract process is implemented using a least recently used (LRU) algorithm. In this algorithm, the maintenance of the contract process needs a linked list. However, since operations of the linked list are usually complicated, a large amount of docker resources need to be occupied. Therefore, how to improve the transaction processing efficiency based on occupying smaller resources is a technical problem that needs to be continuously researched.

### SUMMARY

To solve the foregoing technical problem, embodiments of the present disclosure provide a block chain-based transaction processing method, a block chain-based transaction processing apparatus, an electronic device, a computer-readable storage medium, and a computer program product.

According to an aspect of the embodiments of the present disclosure, a block chain-based transaction processing method is provided, including the following operations: determining a smart contract configured for processing a transaction; determining a target resident contract process according to flag values corresponding to resident contract processes recorded in a maintenance array, each of the flag values indicating an execution state of a corresponding resident contract process, and a maximum number of resident contract processes recorded in the maintenance array being a maximum number of contract processes supported by a docker deployed in the block chain node; replacing, in the maintenance array, the target resident contract process with a target contract process corresponding to the smart contract, and modifying a target flag value corresponding to the target contract process to a first value, the first value characterizing that a corresponding contract process is in an executed state; and transmitting the transaction to the target contract process for processing.

According to an aspect of the embodiments of the present disclosure, a block chain-based transaction processing apparatus is provided, including: a first determining module configured to determine a smart contract configured for processing a transaction; a second determining module configured to determine a target resident contract process according to flag values corresponding to resident contract processes recorded in a maintenance array, each of the flag values indicating an execution state of a corresponding resident contract process, and a maximum number of resident contract processes recorded in the maintenance array being the maximum number of contract processes supported by a docker deployed in the block chain node; an array processing module configured to replace, in the maintenance array, the target resident contract process with a target contract process corresponding to the smart contract, and modify a target flag value corresponding to the target contract process to a first value, the first value characterizing that a corresponding contract process is in an executed state; and a transaction processing module configured to transmit the transaction to the target contract process for processing.

According to an aspect of the embodiments of the present disclosure, an electronic device is provided, including: one or more processors; and a storage apparatus configured to store one or more computer programs, the one or more computer programs, when executed by the one or more processors, causing the electronic device to implement the foregoing block chain-based transaction processing method.

According to an aspect of the embodiments of the present disclosure, a computer-readable storage medium is provided, having a computer program stored therein, and the computer program, when executed by a processor of a block chain node, causes the processor to perform the foregoing block chain-based transaction processing method.

In the technical solutions provided in the embodiments of the present disclosure, the maintenance array is provided to maintain the execution of the smart contract in the block chain node. Specifically, the maintenance array records a resident contract process set and the flag values of the resident contract processes in the block chain node. When a contract process needs to be swapped in/out, a target resident contract process that needs to be swapped out is determined according to the flag values of the resident contract processes in the maintenance array. Since the flag value may reflect the execution state of the corresponding resident contract process, the target resident contract process to be replaced by the target contract process may be more accurately determined based on this. Then, the target resident contract process is replaced with the target contract process that needs to be swapped in. Compared with executing and maintaining the smart contract using a linked list, in the present disclosure, an operation manner based on the maintenance array is simpler, and docker resources required to be occupied are smaller, thereby improving the transaction processing efficiency.

The foregoing general descriptions and the following detailed descriptions are merely for illustration and explanation purposes and are not intended to limit the present disclosure.

### BRIEF DESCRIPTION OF THE DRAWINGS

FIG. 1 is a schematic structural diagram of a block chain system according to an exemplary embodiment.

FIG. 2 is a schematic structural diagram of a contract execution docker configured in a block chain node.

FIG. 3 is a schematic diagram of an exemplary contract process execution time sequence.

FIG. 4 is a schematic diagram of a linked list operation process corresponding to the contract process execution time sequence shown in FIG. 3.

FIG. 5 is a flowchart of a block chain-based transaction processing method according to an exemplary embodiment of the present disclosure.

FIG. 6 is a flowchart of another block chain-based transaction processing method based on the embodiment shown in FIG. 5.

FIG. 7 is a flowchart of another block chain-based transaction processing method based on the embodiment shown in FIG. 5.

FIG. 8 is a schematic diagram of an exemplary initialization process of a maintenance array.

FIG. 9 is a flowchart of another block chain-based transaction processing method based on the embodiment shown in FIG. 5.

FIG. 10 is a schematic diagram of another exemplary contract process execution time sequence.

FIG. 11 is a schematic diagram of an array operation process corresponding to contract process execution time sequences 5 to 10 shown in FIG. 10.

FIG. 12 is a schematic diagram of an exemplary regular presentation of smart contracts invoked by a user.

FIG. 13 is a schematic presentation diagram of an exemplary statistical result obtained by continuously counting the number of resident contract processes within a period of time and current central processing unit (CPU) utilization rates of a block chain node.

FIG. 14 is a flowchart of a block chain-based transaction processing method according to an exemplary application scene.

FIG. 15 is a block diagram of a block chain-based transaction processing apparatus according to an exemplary embodiment of the present disclosure.

FIG. 16 is a schematic structural diagram of a computer system adapted to implement an electronic device according to an embodiment of the present disclosure.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with the present disclosure. On the contrary, the implementations are merely examples of an apparatus and a method that are consistent with some aspects of the present disclosure described in detail in claims.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change according to an actual case.

“A plurality of” mentioned in the present disclosure refers to two or more. “And/or” describes an association relationship of associated objects and represents that three relationships may exist. For example, A and/or B may represent the following three cases: only A exists, both A and B exist, and only B exists. The character “/” generally represents an “or” relationship between the associated objects.

The embodiments of the present disclosure relate to a block chain technology. The block chain technology is a brand new distributed infrastructure and calculation manner in which data is verified and stored using a block chain data structure, data is generated and updated using a distributed node consensus algorithm, security of data transmission and access is ensured using a cryptological manner, and data is programmed and operated using a smart contract including automated script code. A block chain refers to a decentralized infrastructure with the characteristics of distributed storage, and specifically, is a data structure that forms data blocks according to a time sequence in a manner similar to a linked list, can securely store sequential data that can be verified in a system, and ensure, in a cryptological manner, that data cannot be tampered or forged. Simply, the block chain is a decentralized distributed account book, and each chain is equivalent to an independent account book.

FIG. 1 is a schematic structural diagram of a block chain system according to an exemplary embodiment. A block chain system 100 shown in FIG. 1 may contain a node device 10a, a node device 10b, a node device 10c, and a node device 10d. The node device 10a, the node device 10b, the node device 10c, and the node device 10d are all block chain nodes (nodes for short) in the block chain system 100 shown in FIG. 1. These nodes may be any form of computing devices accessed to the block chain system 100, such as a server and a user terminal. The node device 10a, the node device 10b, the node device 10c, and the node device 10d shown in FIG. 1 may further be connected by network communication to form the block chain system 100.

Types of block chains involved in the architecture of the block chain system 100 shown in FIG. 1 may specifically include: a public blockchain, a private blockchain, and a consortium blockchain. Types of block chains used in different block chain application scenes may be different and are not limited herein. The public blockchain refers to a block chain that is publicly available and may be joined and accessed by anyone. Blocks on the public blockchain may be viewed by anyone, and anyone may initiate a transaction on the public blockchain and may further participate in a consensus process of the public blockchain at any time. The private blockchain may be used in a private organization, and the read-write permission and accounting participation permission on the block chain may be formulated according to a rule of the private organization. The private blockchain is usually configured for data management, auditing, and the like within an enterprise. The consortium blockchain refers to that read-write permissions and accounting participation permissions of consortium members participating in the consortium blockchain on the block chain may be formulated according to a consortium rule. The consortium blockchain is generally used in scenes such as transactions, settlements, or clearings between institutions.

Each node in the block chain system 100 has a corresponding node identifier and may store node identifiers of other nodes in the block chain system 100 to subsequently broadcast a generated block to other nodes in the block chain system 100 according to the node identifiers of other nodes. Each node in the block chain system 100 stores the same block chain (referring to the block chain 10e shown in FIG. 1). Therefore, the block chain system 100 may further be referred to as a data sharing system.

As described above, with the development of docker technologies, more block chain technologies support a docker as a virtual machine of a smart contract. In this way, a limitation of a smart contract language may be shielded, and smart contracts of various development languages may be supported. For example, it is assumed that a block chain program is developed in the go language and may completely support smart contracts in languages such as java and python through a docker technology.

Since the docker technology is isolated from block chain nodes, smart contracts need to be maintained in the docker. However, the docker generally limits resources such as memory. Therefore, the maximum number of supported contract processes is usually configured in the docker to represent the maximum number of contracts executed in parallel in the docker. Under the limit of the maximum number of contract processes, contract processes need to be swapped in/out, i.e., exiting some contract processes, and adding other contract processes.

In some cases, an LRU algorithm is adopted to implement swapping in/out of the contract process. In this algorithm, the maintenance of the contract process needs a linked list. However, since operations of the linked list are usually complicated, a large amount of docker resources need to be occupied.

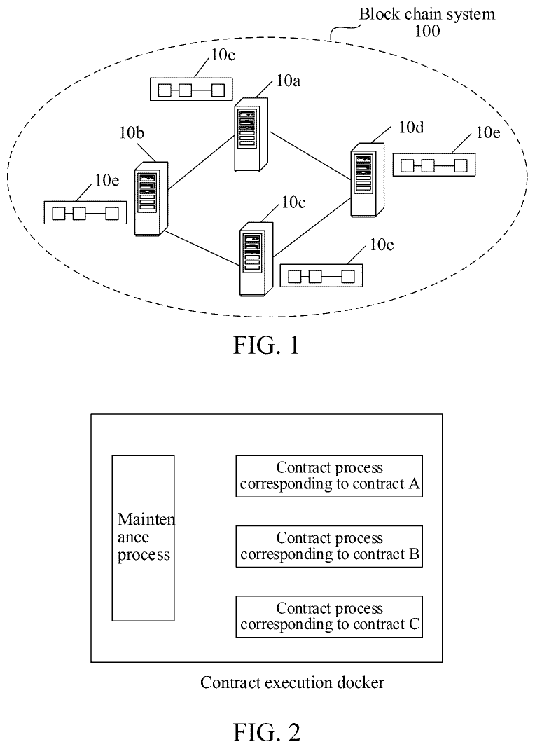

FIG. 2 is a schematic structural diagram of a contract execution docker configured in a block chain node. As shown in FIG. 2, a maintenance process and three contract processes are provided in the contract execution docker. The three contract processes are resident contract processes. The maintenance process is configured for scheduling the contract processes in the contract execution docker, and an LRU algorithm is implemented through the maintenance process.

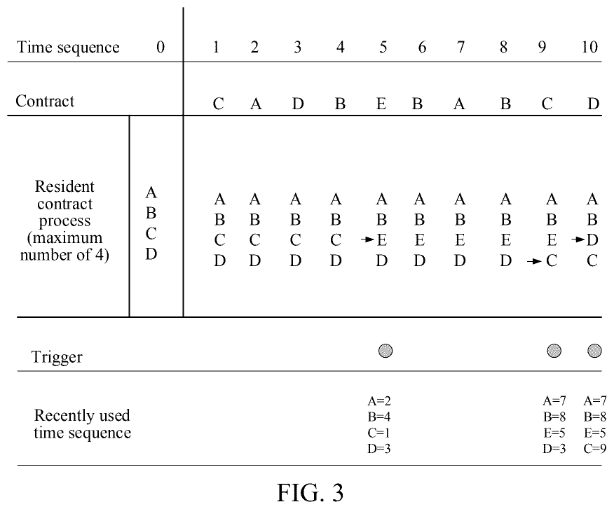

For further ease of understanding a process of swapping in/out a contract process implemented by the LRU algorithm, FIG. 3 is a schematic diagram of an exemplary contract process execution time sequence. As shown in FIG. 3, if it is assumed that the maximum number of contract processes supported by the docker is 4, a resident contract process set contains 4 contract processes. The resident contract process set is a set of contract processes that normally live in the docker most time in a period of time. Since the docker supports at most four contract processes executed in parallel, the number of the resident contract processes contained in the resident contract process set is 4.

It is further assumed in FIG. 3 that an entry sequence of contract processes in an initial resident contract process set is A, B, C, and D, that is, when the time sequence is 0, the resident contract process set contains contract processes A, B, C, and D. When the time sequence is 1, a contract process corresponding to the contract C needs to be executed. Since the resident contract process set contains the contract process corresponding to the contract C, the contract process corresponding to the contract C is directly executed. A contract process mentioned in the present disclosure is a contract process corresponding to a smart contract. For example, the contract process A is a contract process corresponding to a smart contract A.

The execution of the contract process A when the time sequence is 2, the execution of the contract process D when the time sequence is 3, and the execution of the contract process B when the time sequence is 4 are similar to the execution of the contract process when the time sequence is 0, and details are not described herein again.

When the time sequence is 5, a contract process E needs to be executed. Since there is no contract process E in the current resident contract process set, a contract process needs to be swapped out from the existing resident contract process set to swap in the contract process E. According to a recently used time sequence, it may be learned that the contract process C is executed the earliest, that is, a contract process corresponding to the contract C is recently executed the farthest from the current time. Therefore, after the contract process C is swapped out from the resident contract process set, the contract process E is added to the resident contract process set.

Resident contract process sets corresponding to time sequences 6 to 8 each include contract processes A, B, E, and D. Since contract processes that need to be executed at a current moment are all existing resident contract processes, the corresponding resident contract processes may be directly executed.

When the time sequence is 9, the contract process C needs to be executed. Since there is no contract process C in the current resident contract process set, a contract process needs to be swapped out from the existing resident contract process set to swap in the contract process C. According to a recently used time sequence, it may be learned that the contract process D is executed the earliest. Therefore, after the contract process D is swapped out from the resident contract process set, the contract process C is added to the resident contract process set.

When the time sequence is 10, the contract process D needs to be executed. Since there is no contract process D in the current resident contract process set, according to a recently used time sequence, it may be learned that the contract process E is executed the earliest. Therefore, after the contract process E is swapped out from the resident contract process set, the contract process D is added to the resident contract process set.

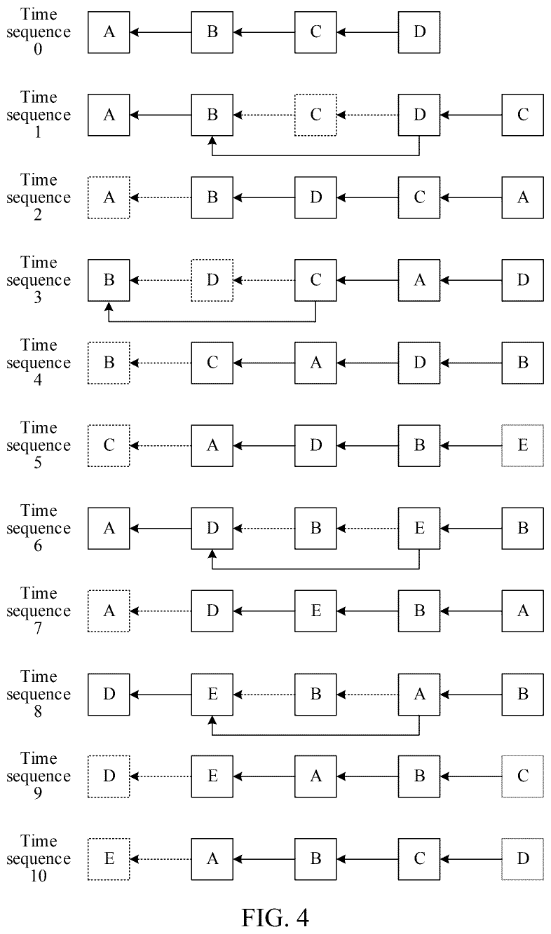

FIG. 4 is a schematic diagram of a linked list operation process corresponding to the contract process execution time sequence shown in FIG. 3. As shown in FIG. 4, when the time sequence is 0, contract processes A to D are linked in sequence in a chain. The contract process A is located at the head of the linked list, and the contract process D is located at the tail of the linked list. When the time sequence is 1, since the contract process C needs to be executed, the contract process C needs to be moved to the tail of the linked list, and a link between the contract process B and the contract process D is reestablished. When the time sequence is 2, since the contract process A that needs to be executed is located at the head of the linked list, the contract process A needs to be moved to the tail of the linked list. Linked list operation processes of the time sequences 3 to 4 and the time sequences 6 to 8 are similar, and details are not described herein again.

During the time sequences 1 to 4, the resident contract process set includes contract processes A, B, C, and D, and during the time sequences 6 to 8, the resident contract process set includes contract processes A, B, E, and D. It can be seen that although in these time sequences, a contract process that needs to be executed is an existing resident contract process and a swapping in/out operation is not needed, a link relationship of elements in the linked list still needs to be modified.

When the time sequence is 5, since the contract process E that needs to be executed is not in the resident contract process set, a contract process needs to be swapped out from the resident contract process set. Therefore, the contract process C located at the head of the linked list is swapped out, and the contract process E is added to the tail of the linked list. Linked list implementation processes are similar to this when the time sequences are 9 to 10, and details are not described herein again.

It can be seen from the linked list implementation process shown in FIG. 4 that, in the LRU algorithm, each time a contract process is executed, an operation is performed on the linked list, so as to put the contract process at a correct position. When a contract process is missing, that is, when the resident contract process set does not contain a to-be-executed contract process, a contract process needs to be swapped in/out, a contract process at the head of the linked list needs to be swapped out, and a new contract process is added to the tail of the linked list.

Resource overheads of the LRU algorithm are very large, for example, at least the following reasons are included.
1. Elements in the linked list are actually allocated to different pages in a memory. This causes performance degradation in two aspects. In the first aspect, a program locality principle cannot be used well so that each time the elements in the linked list are operated, multiple addressing will be involved. In the second aspect, since elements in the linked list are allocated to different memory pages, when a CPU triggers a page default interrupt, the elements are affected.

The program locality principle refers to that a program presents a locality rule when being executed. That is, within a period of time, execution of an entire program is limited to a part of the program. Correspondingly, a storage space accessed during execution is also limited to a particular memory area. Therefore, a linked list operation involved in the LRU algorithm needs to consume a large amount of memory resources.
2. Operations of the linked list cannot be parallel because different contract threads need to perform locking when operating the linked list, so as to facilitate correctness of the linked list. It is well-known that locking is very performance-consuming.
3. The linked list needs to maintain relatively large resources. The reasons are that each element needs to contain a parent element and a child element thereof, and when an element is deleted, manual (or a garbage collection policy supported by some programs) recovery needs to be performed.

It can be known from the foregoing aspects that the LRU algorithm involves multiple race conditions. When a block chain transaction needs to be executed, the efficiency of transaction processing using a corresponding contract process is relatively low. To solve the technical problem, embodiments of the present disclosure provide a block chain-based transaction processing method, a block chain-based transaction processing apparatus, an electronic device, a computer-readable storage medium, and a computer program product.

These embodiments are described in detail below.

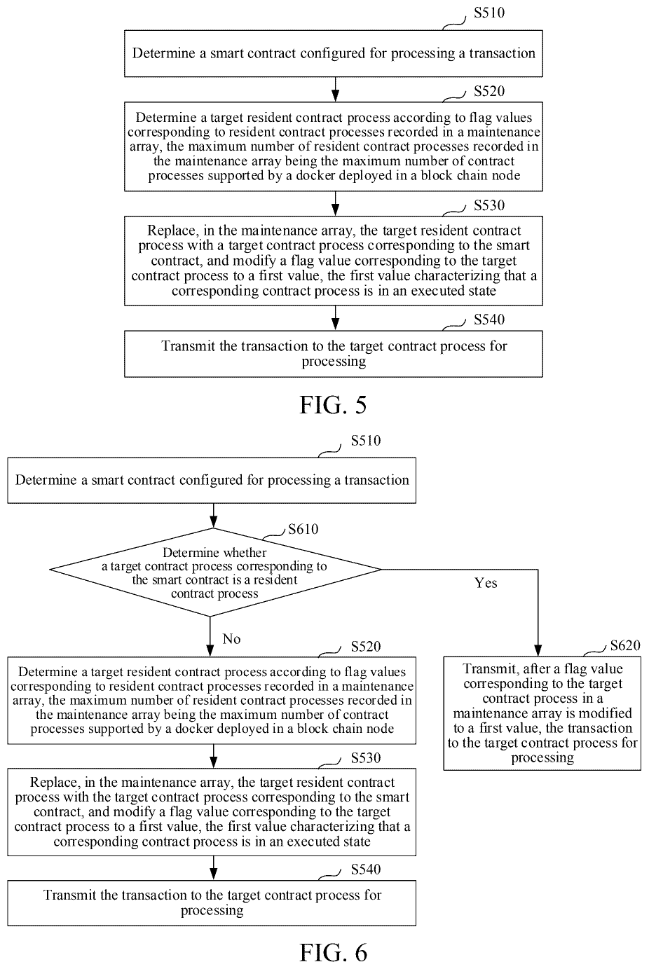

FIG. 5 is a flowchart of a block chain-based transaction processing method according to an exemplary embodiment of the present disclosure. The method may be performed by a block chain node. Specifically, the method may be performed by a maintenance thread in a docker deployed in the block chain node, for example, performed by a maintenance thread in a contract process docker shown in FIG. 2. Certainly, the method may alternatively be performed by another block chain node device that supports the docker as a virtual machine of the smart contract, to efficiently process a block chain transaction. An execution body of the method is not limited herein.

As shown in FIG. 5, the method includes S510 to S540. A detailed description is as follows.
S510: determine a smart contract configured for processing a transaction.

In an actual application scene, to adapt to a service requirement, a plurality of smart contracts configured for processing transactions are usually installed in the block chain node. Different smart contracts have different service logics. Therefore, after acquiring a to-be-processed transaction, the block chain node may query a smart contract configured for processing the transaction to determine the smart contract configured for processing the transaction.

In the block chain technology, a transaction is a digital record. Transaction data is broadcast in a network-wide range through a block chain network and confirmed and verified in the network-wide range through a consensus mechanism so that the transaction is irreversible and can be prevented from tampering. If the block chain is considered as a distributed account book that is continuously synchronized in real time, in this account book, each action may be considered as a transaction.
S520: determine a target resident contract process according to flag values corresponding to resident contract processes recorded in a maintenance array, the maximum number of resident contract processes recorded in the maintenance array being the maximum number of contract processes supported by a docker deployed in a block chain node.

As described above, the docker deployed in the block chain node is used as the virtual machine of the smart contract so that the smart contract needs to be executed and maintained in the docker. In this embodiment, the maintenance array is provided to help execute and maintain the contract process in the docker.

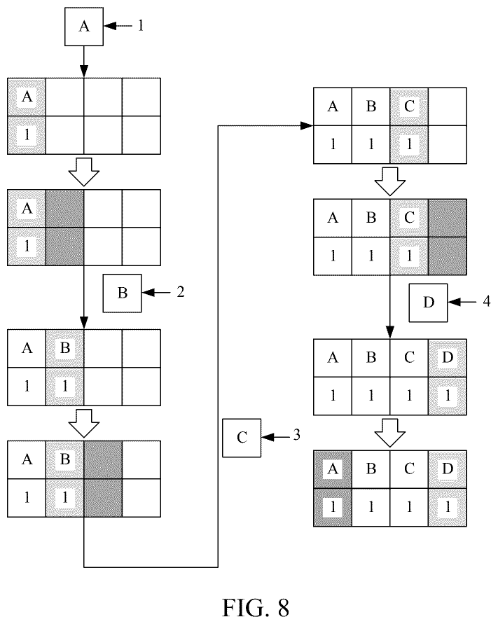

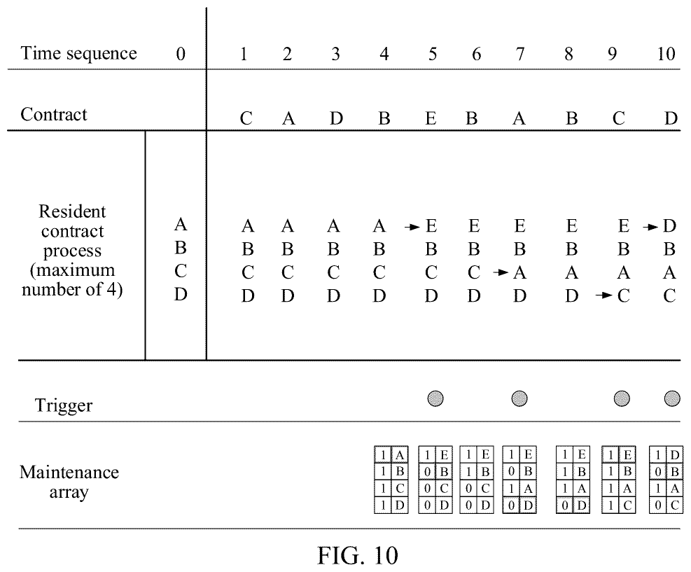

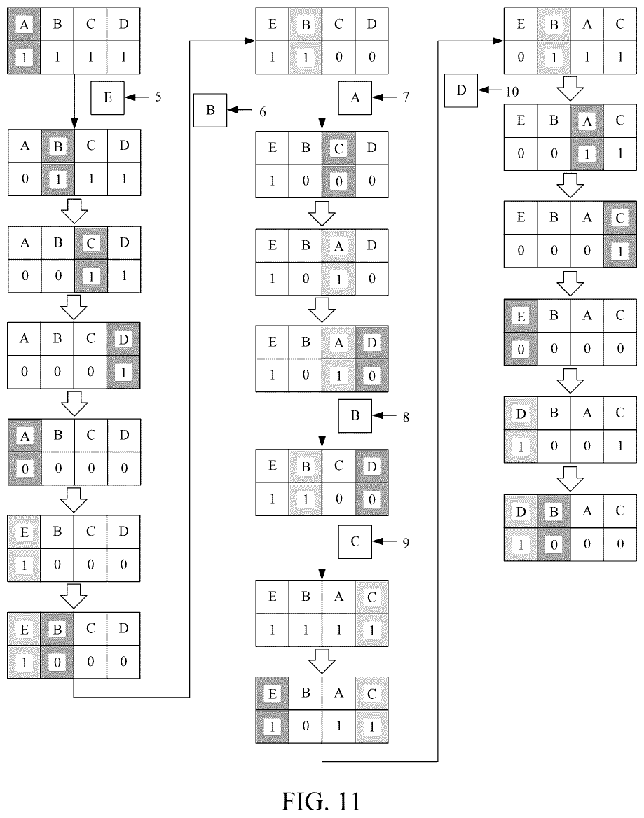

The maintenance array is configured for recording a resident contract process set. The maximum number of resident contract processes recorded in the maintenance array is the maximum number of contract processes supported by the docker. Therefore, the maximum number of array elements contained in the maintenance array is the same as the maximum number of contract processes supported by the docker, and each resident contract process is correspondingly recorded at each element position. Since the docker generally limits resources such as memory, the maximum number of supported contract processes is usually configured in the docker to represent the maximum number of contracts executed in parallel in the docker. For example, as shown in FIG. 8, FIG. 10, and FIG. 11, in an exemplary maintenance array, the recorded resident contract process set contains four resident contract processes.

A contract process is essentially a smart contract program deployed on the block chain node, and a resident contract process is essentially a smart contract program that can be executed in a docker. The maintenance array mentioned in this embodiment is configured for execution and maintenance of the contract process in the docker. Therefore, recording the resident contract process at the element position of the maintenance array mentioned in this embodiment is essentially recording a name of the resident contract process at the element position, that is, the content of the array elements contained in the maintenance array is to be names of the resident contract processes.

It can be seen that when a contract process outside the resident contract process set needs to be executed, a contract process needs to be swapped in/out, that is, a contract process is swapped out from the current resident contract process set, and a contract process that needs to be executed is swapped in the resident contract process set. A process of swapping in/out a contract process may alternatively be referred to as missing. The missing refers to that a current contract process cannot process a transaction, an existing contract process needs to be exited, and a new contract process needs to be added.

In this embodiment, the maintenance array is further provided with a flag bit, and a flag bit is provided for each array element. The flag bit is configured for recording a flag value of a corresponding array element. The flag value is configured for characterizing an execution state of the corresponding array element. Different flag values characterize different execution states of a contract process. Illustratively, when the flag value of the flag bit is a first value, the corresponding contract process is in an executed state. The executed state may be understood as that the corresponding contract process has been executed recently. A time length configured for measuring whether the contract process is executed recently may be a preset value and is not limited herein. When the flag value is a second value, the corresponding contract process is in a non-executed state. Correspondingly, the non-executed state may be understood as that the corresponding contract process has not been executed recently. Therefore, when a contract process is swapped in/out, a resident contract process with the flag value of the second value is usually determined as a target resident contract process that needs to be swapped out from the resident contract process set.

Illustratively, if there is one resident contract process contained in the current resident contract process set with the flag value of the second value, the resident contract process may be directly determined as the target resident contract process that needs to be swapped out. If there are a plurality of resident contract processes contained in the resident contract process set with the flag value of the second value, one of the resident contract processes is determined as the target resident contract process. Usually, a resident contract process with a first flag bit of the second value is determined as the target resident contract process. A determining manner may refer to descriptions in subsequent embodiments, and details are not described herein again. If there is no resident contract process contained in the resident contract process set with the flag value of the second value, the target resident contract process needs to be determined after the flag value of the resident contract process is modified to the first value. Details may refer to descriptions in subsequent embodiments, and details are not described herein again.

In some exemplary implementations, the first value may be 1, and the second value may be 0 so that flag bits of the array elements may be implemented with at least one bit only. Therefore, very few resources need to be occupied. In another implementation, the first value and the second value may alternatively be other values other than 0 or 1. This is not limited herein.

In some exemplary embodiments, after S510, whether the smart contract configured for processing the transaction is installed on the block chain node is further queried. If it is determined that the smart contract configured for processing the transaction is installed on the block chain node, the content of S520 is performed. If it is determined that the smart contract configured for processing the transaction is not installed on the block chain node, prompt processing indicating that the contract does not exist is performed. For example, a corresponding prompt message is generated and fed back to the user. Illustratively, the block chain node maintains a smart contract list, and the smart contract list records a contract name of the smart contract that is installed on the block chain node. Therefore, whether the smart contract configured for processing the transaction is installed on the block chain node may be queried by acquiring the smart contract list and then searching the smart contract list for the contract name corresponding to the smart contract configured for processing the transaction.
S530: replace, in the maintenance array, the target resident contract process with a target contract process corresponding to the smart contract, and modify a target flag value corresponding to the target contract process to a first value.

After the target resident contract process that needs to be swapped out is determined based on the maintenance array, the target resident contract process in the maintenance array is replaced with the target contract process corresponding to the smart contract configured for processing the transaction that is determined in S510, and then the target flag value corresponding to the target contract process is modified to the first value in the maintenance array.

In this embodiment, the target resident contract process in the maintenance array is replaced with the target contract process so that the target contract process is added to the resident contract process set, that is, the resident contract process is updated. In this embodiment, the target flag value corresponding to the target contract process is further modified to the first value in the maintenance array to characterize, through the first value, that the target contract process has been executed recently so that a corresponding target resident contract process is determined based on the flag value when a contract process is swapped in/out next time.
S540: transmit the transaction to the target contract process for processing.

Based on the modification of the flag value performed in S530, the target contract process is marked as a new resident contract process. Therefore, the to-be-processed transaction may be transmitted to the target contract process so that the transaction is processed through the target contract process.

It can be seen from the foregoing that according to the transaction processing method provided in this embodiment, the maintenance array is provided to maintain the execution of the smart contract in the block chain node. Specifically, the maintenance array records the resident contract process set and the flag values of the resident contract processes in the block chain node. When a contract process needs to be swapped in/out, the target resident contract process that needs to be swapped out is determined according to the flag values of the resident contract processes in the maintenance array, and then the target resident contract process is replaced with a target contract process that needs to be swapped in.

Compared with the related art in which the smart contract is executed and maintained using the linked list, the maintenance array used in this embodiment has a compact structure, the data structure occupies a very small memory and is unlikely to span a plurality of memory pages, thereby reducing the performance loss caused by swapping out of memory page defaults. In addition, since this embodiment relates to an array operation, there is no operation contention, and different array elements may be operated in parallel, thereby further reducing the performance loss. Furthermore, since elements in the array may be completely operated concurrently, performance consumption in the block chain node can be saved. It can be seen that, in the present disclosure, an operation manner based on the maintenance array is simpler, and docker resources required to be occupied are smaller, thereby improving the transaction processing efficiency.

FIG. 6 is a flowchart of another block chain-based transaction processing method based on the embodiment shown in FIG. 5. As shown in FIG. 6, based on S510 to S540 shown in FIG. 5, the block chain-based transaction processing method further includes the following S610 and S620.
S610: determine whether the target contract process corresponding to the smart contract is the resident contract process.
S620: transmit, after the target flag value corresponding to the target contract process in the maintenance array is modified to the first value, the transaction to the target contract process for processing.

The related determination performed in S610 is further implemented based on the maintenance array. Specifically, after the target contract process is determined, whether the target contract process is one of the resident contract processes may be determined by querying whether the target contract process is an array element in the maintenance array. If the target contract process is the array element in the maintenance array, it is determined that the target contract process is one of the resident contract processes. Otherwise, if the target contract process is not the array element in the maintenance array, it is determined that the target contract process is not one of the resident contract processes.

If a determining result in S610 is no, that is, it is determined that the target contract process is not one of the resident contract processes, it is considered that missing is triggered, that is, a contract process needs to be swapped in/out. Therefore, S520 is performed.

If the determining result in S610 is yes, that is, it is determined that the target contract process is one of the resident contract processes, the target contract process is directly used for transaction processing. Therefore, the content shown in S620 is performed. After the target flag value corresponding to the target contract process in the maintenance array is modified to the first value, the transaction is transmitted to the target contract process for processing.

FIG. 3 is still used as an example for description. When the time sequences are 1 to 4 and 6 to 8, contract processes that need to be executed are all existing resident contract processes, and when the time sequences are 5 and 9 to 10, contract processes that need to be executed are not existing resident contract processes. Therefore, various smart contract execution situations easily occur in an actual application scene. Further, in this embodiment, by determining whether the target contract process is one of the resident contract processes, suitable step content can be selected for processing based on a determining result. In this way, this is more practical to the actual application scene.

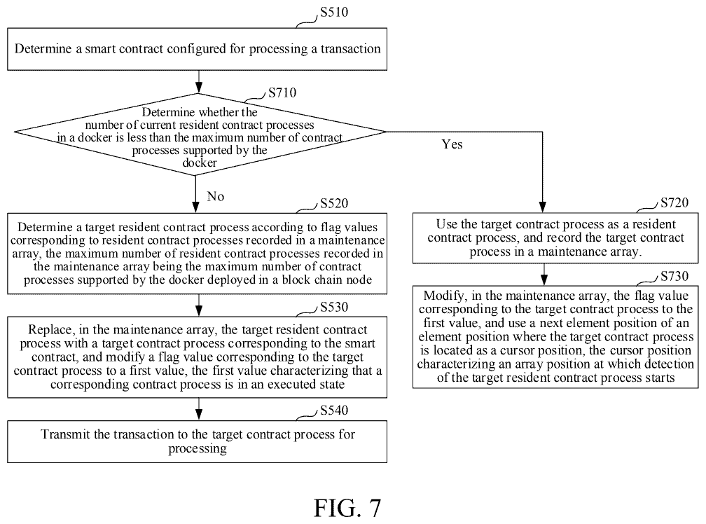

FIG. 7 is a flowchart of another block chain-based transaction processing method based on the embodiment shown in FIG. 5. As shown in FIG. 7, based on S510 to S540 shown in FIG. 5, the block chain-based transaction processing method further includes the following S710, S720, and S730.
S710: determine whether the number of current resident contract processes in the docker is less than the maximum number of contract processes supported by the docker.
S720: use the target contract process as the resident contract process, and record the target contract process in the maintenance array.
S730: modify, in the maintenance array, the target flag value corresponding to the target contract process to the first value, and use a next element position of an element position where the target contract process is located as a cursor position, the cursor position characterizing an array position at which detection of the target resident contract process starts.

In this embodiment, the number of current resident contract processes in the docker needs to be acquired. The number of current resident contract processes in the docker may be acquired according to the number of resident contract processes recorded in a current maintenance array.

An objective of determining whether the number of current resident contract processes in the docker is less than the maximum number of contract processes supported by the docker in S710 is to determine whether the number of current resident contract processes reaches a docker limit. If a determining result in S710 is yes, that is, the number of current resident contract processes in the docker is less than the maximum number of contract processes supported by the docker, the docker may support directly adding the target contract process to the resident contract process set. Therefore, S720 to S730 are performed, i.e., using the target contract process as the resident contract process, recording the target contract process in the maintenance array, and modifying, in the maintenance array, the target flag value corresponding to the target contract process to the first value.

In S730, the next element position of the element position where the target contract process is located is further used as the cursor position, and the cursor position characterizes the array position at which detection of the target resident contract process starts. The cursor position is provided in the maintenance array so that the detection of the target resident contract process needing to be swapped out from the resident contract process set is performed from the cursor position when the swapping in/out of a contract process is triggered next time. Detailed content of the detection process is recorded in the next embodiment, and details are not described herein again.

If the determining result in S710 is no, that is, the number of current resident contract processes in the docker is not less than the maximum number of contract processes supported by the docker, if the target contract process is directly executed, overuse of the docker resource may be caused. Therefore, S520 needs to be performed to perform transaction processing through the target contract process after the contract process is swapped in/out.

By comparing the number of current resident contract processes and the maximum number of contract processes of the block chain node, whether the target resident contract process is determined from the resident contract processes of the maintenance array or the target contract process is added as the resident contract process to the maintenance array may be selected in a targeted manner based on the determining result, thereby effectively improving the resource utilization efficiency.

In an initialization process of the maintenance array shown in FIG. 8, when the time sequence is 0, the maintenance array is empty. When the time sequence is 1, the contract process A needs to be executed. Since the number 0 of current resident contract processes in the docker is less than the maximum number 4 of contract processes supported by the docker, the contract process A is recorded into the maintenance array as a resident contract process, a flag value of the contract process A is modified to a first value 1, and a next array position of the contract process A is used as the cursor position. A process in which the contract process B needs to be executed when the time sequence is 2 and a process in which the contract process C needs to be executed when the time sequence is 3 is similar to a processing process when the time sequence is 1, and details are not described herein again.

When the time sequence is 4, the contract process D needs to be executed, and the number 3 of current resident contract processes in the docker is less than the maximum number 4 of contract processes supported by the docker. Therefore, the contract process D is recorded into the maintenance array as a resident contract process, and a flag value of the contract process D is modified to the first value 1. However, since the contract process D is located at the last element position of the maintenance array, if a next array position of the contract process D is used as the cursor position, the cursor position will be out of bounds. In this case, the start element position of the maintenance array is used as the cursor position.

In the maintenance array shown in FIG. 8, an element position filled with relatively dark gray represents a cursor position, and an element position filled with relatively light gray represents a digital element newly added to the resident contract process set. It can be seen from FIG. 8 that, after the contract process D corresponding to the time sequence 4 is added to the maintenance array, since the cursor position is out of bounds, a start element position of the maintenance array is used as the cursor position.

It can be seen from the foregoing that, in this embodiment, by further introducing a comparison between the number of current resident contract processes in the docker and the maximum number of contract processes supported by the docker, suitable step content can be selected for processing based on a determining result, and an application requirement of the maintenance array at an initialization stage can be satisfied, thereby being further practical to the actual application scene.

It can be further seen from the foregoing that the maintenance array involved in this embodiment has a circular array structure, that is, in an array structure, the tail and the head of the maintenance array are connected to form the circular array structure. Such a circular array structure allows for an out-of-bounds phenomenon.

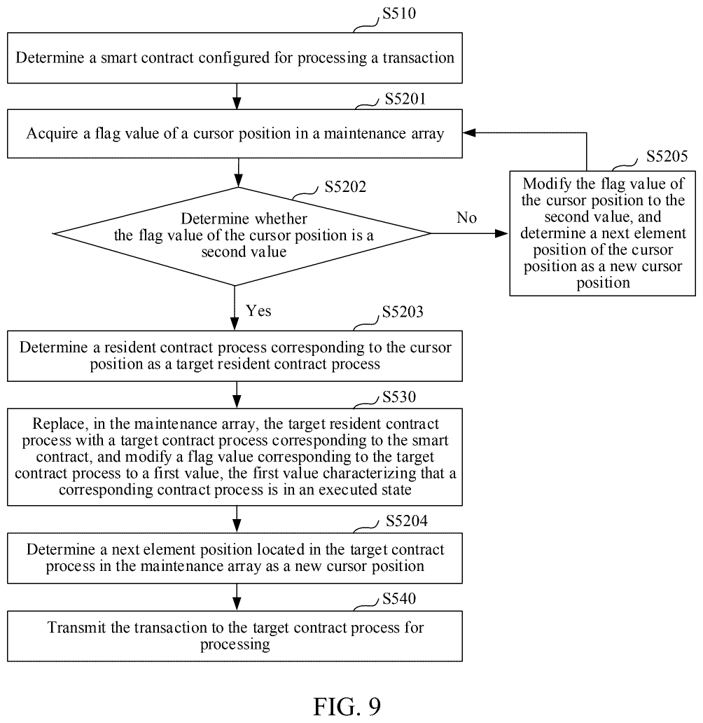

FIG. 9 is a flowchart of another block chain-based transaction processing method based on the embodiment shown in FIG. 5. As shown in FIG. 9, based on S510 to S540 shown in FIG. 5, S520 specifically includes S5201 to S5203, and the method further includes S5204 and S5205. Details are as follows.
S5201: acquire a flag value of a cursor position in the maintenance array.
S5202: determine whether the flag value of the cursor position is a second value. If yes, S5203 is performed, and if not, S5205 is performed.
S5203: determine a resident contract process corresponding to the cursor position as the target resident contract process.
S5204: determine a next element position located in the target contract process in the maintenance array as a new cursor position.
S5205: modify the flag value of the cursor position to the second value, and determine a next element position of the cursor position as the new cursor position.

As described above, the cursor position in the maintenance array characterizes an element position at which detection of the target resident contract process starts. Therefore, when the target resident contract process is detected, the flag value of the cursor position in the maintenance array needs to be acquired.

After the flag value of the cursor position is acquired, whether the flag value of the cursor position is the second value needs to be determined. The second value characterizes that the corresponding contract process is in a non-executed state. If a determining result in S5202 is yes, the resident contract process corresponding to the cursor position has not been used recently, and therefore, it may be determined as a target resident contract process that needs to be swapped out. Moreover, after the target contract process is swapped in the resident contract process set, that is, the target resident contract process in the maintenance array is replaced with the target contract process, and the flag value of the target contract process is modified to the first value in the maintenance array, the next element position located in the target contract process in the maintenance array is determined as the new cursor position.

If the determining result in S5202 is no, the resident contract process corresponding to the cursor position has been used recently and is not suitable to be used as the target resident contract process. Therefore, the flag value of the cursor position is modified to the second value, the next element position of the cursor position is determined as the new cursor position, and then the content of S5201 is performed, that is, the target resident contract process is redetected in the maintenance array. Based on this process, a finally determined target resident contract process is usually a resident contract process that has not been processed for a longest time, more satisfying actual processing logic.

Similarly, in the foregoing process of updating the cursor position, if the cursor position determined based on the next element position is out of bounds, a start element position of the maintenance array is determined as the cursor position.

For ease of understanding the foregoing processing procedure, FIG. 10 and FIG. 11 are referred. FIG. 10 is a schematic diagram of another exemplary contract process execution time sequence. FIG. 11 is a schematic diagram of an array operation process corresponding to contract process execution time sequences 5 to 10 shown in FIG. 10. In addition, in the maintenance array shown in FIG. 11, an element position filled with relatively dark gray represents a cursor position, and an element position filled with relatively light gray represents a digital element newly added to the resident contract process set.

As shown in FIG. 10 and FIG. 11, when the time sequence is 5, the target contract process E needs to be executed. A cursor position in a current maintenance array is an element position where the contract process A is located. Since the contract process E is deployed in the resident contract process, the flag value of the cursor position is acquired to be the first value 1 but not the second value 0. Therefore, the flag value of the cursor position is modified to the second value 0, a next element position is determined as a new cursor position. A flag value of the new cursor position is acquired to still be the first value 1. Therefore, the flag value of the cursor position still needs to be modified to the second value 0, and then a next element position is determined as a new cursor position. This is cyclically executed. After a flag value of the last element of the maintenance array is modified to the second value 0, a start element of the maintenance array is determined as a new cursor position. Since a flag value of the cursor position at this time is the second value 0, a resident contract process A corresponding to the cursor position is used as a target resident contract process that needs to be swapped out, and is replaced with a to-be-executed target contract process E. In addition, a flag value of the target contract process E is modified to the first value 1, and a next element position of the target contract process E is used as the cursor position.

When the time sequence is 6, the target contract process B needs to be executed. Since the target contract process B is already a resident contract process, the flag value of the target contract process B is directly modified to the first value 1 in the maintenance array.

When the time sequence is 7, the target contract process A needs to be executed. Since in a current maintenance array, an element position where the resident contract process B is located is a cursor position (which is the cursor position finally determined in a processing procedure of the time sequence 5), and a flag value of the cursor position is the first value 1, the flag value needs to be modified to the second value 0, and a next element position is determined as a new cursor position. Since a flag value of the new cursor position is the second value 0, the resident contract process C corresponding to this position is replaced with the target contract process A, the flag value of the target contract process A is modified to the first value 1, and a next element position of the target contract process A is used as a new cursor position.

Processing processes of time sequences 8 to 10 are similar to the processing processes of the foregoing time sequences and are not described in detail herein. In summary, in this embodiment, by further introducing determining of the flag value of the cursor position, suitable step content can be selected for processing based on a determining result, and various application requirements in actual application can be satisfied, thereby being further practical and useful to the actual application scene.

In another exemplary embodiment, considering that the maximum number of contract processes supported in a docker is directly configured in the related art, that is, the maximum number of contract processes supported by a docker in the related is a preset value, a change in an application environment cannot be used. After all, in the actual application scene, different resource environments may be different.

Specifically, if the maximum number of contract processes supported by the docker is improperly configured, the following two cases may occur.
1) A configured maximum number of contract processes is excessively large, which easily causes overuse of docker resources so that a contract process is compulsorily stopped by a docker system, or causes frequent swapping in/out operations of memory pages.
2) A configured maximum number of contract processes is excessively small, resulting in that docker resources cannot be fully used, and frequent contract process swapping in/out operations easily occur.

To solve the foregoing problem, this embodiment further provides a solution of determining the maximum number of contract processes supported by the docker. Based on this solution, the maximum number of contract processes supported by the docker may be dynamically adjusted, thereby avoiding the foregoing two cases.

The solution includes S810 to S820, which are described in detail as follows.
S810: detect an average missing time interval of contract processes and an average missing processing time of contract processes in the block chain node.

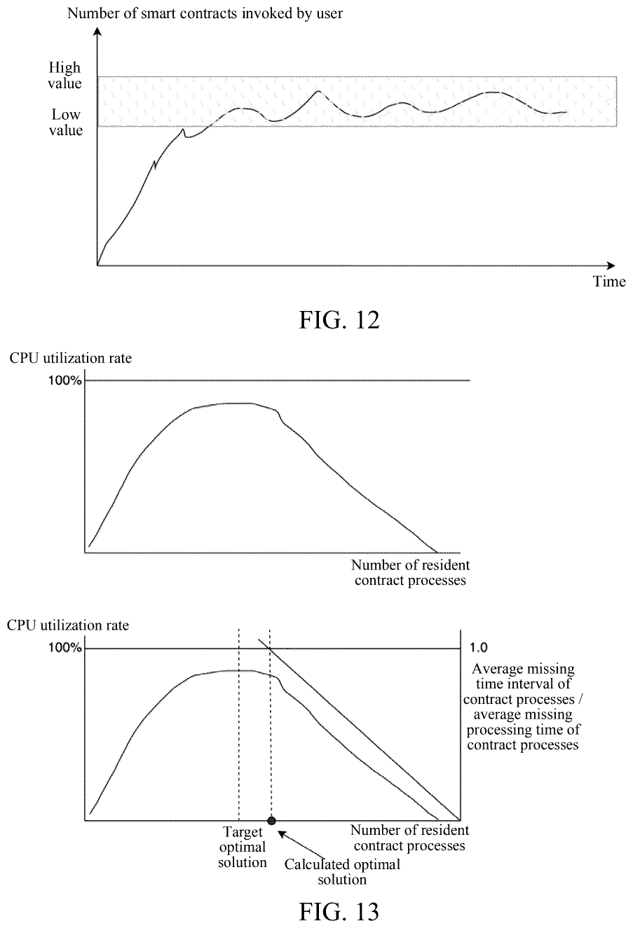

In a block chain system, smart contracts invoked by a user usually present a rule shown in FIG. 12. Specifically, as the time cycle changes, more smart contracts are invoked, but eventually tend to be in a relatively stable range.

According to this rule, this embodiment provides two concepts: an average missing time interval of contract processes and an average missing processing time of contract processes.

The average missing time interval of contract processes characterizes an average time interval between occurrences of missing of contract processes. One occurrence of missing represents one contract process swapping in/out operation. The average missing time interval of contract processes may be obtained by calculating an average value of a plurality of consecutive missing time intervals. For example, in FIG. 3, since missing occurs at each of the time sequences 5, 9, and 10, a time period T1 corresponding to the time sequence 5 to the time sequence 9 and a time period T2 corresponding to the time sequence 9 to the time sequence 10 are two time cycles in which a contract process is missing, and an average missing time interval of contract processes may be obtained by calculating the average value of the two time cycles.

The average missing processing time of contract processes characterizes a time cycle of restarting a missing contract process. That is, when a contract process is missing, how long it takes to start up the contract process.

There is a particular relationship between two parameters, i.e., the average missing time interval of contract processes and the average missing processing time of contract processes. If the average missing time interval of contract processes is greater than the average missing processing time of contract processes, contract processes are not usually missing. In this case, the resource use of the CPU of the block chain node does not reach an upper limit. If the average missing time interval of contract processes is less than the average missing processing time of contract processes, contract processes are frequently missing. In this case, the CPU cannot normally process transactions because it needs to spend a lot of time to process the missing contract processes.

Since the two parameters, i.e., the average missing time interval of contract processes and the average missing processing time of contract processes, both dynamically change as the docker runs, dynamic detection needs to be performed on the two parameters.
S820: determine the maximum number of contract processes supported by the docker based on the average missing time interval of contract processes and the average missing processing time of contract processes.

As described above, the resident contract process set characterizes a set of contract processes that normally live in the docker most time in a period of time. In this embodiment, a set of contract processes that live in the docker at a time point is further referred to as a current contract process set. If the resident contract process set includes the current contract process set, a contract process is not missing. Otherwise, a contract process is missing.

Generally, a large resident contract process set is desirable, because a larger number of contract processes in the resident contract process set indicates that a current contract process set is more likely to be contained in the resident contract process set, and therefore, a contract process is less likely to be missing. However, the large resident contract process set means more resource consumption. Therefore, in this embodiment, a balance needs to be found according to the two parameters, i.e., the average missing time interval of contract processes and the average missing processing time of contract processes.

If the number of resident contract processes within a period of time and current CPU utilization rates of the block chain node are continuously counted, a statistical result shown in the upper figure in FIG. 13 may be obtained. It can be seen that as the number of resident contract processes continuously increases, the CPU utilization rate of the block chain node first increases and then decreases.

If the number of resident contract processes within a period of time, the current CPU utilization rates of the block chain node, the average missing time interval of contract processes, and the average missing processing time of contract processes are continuously counted, a statistical result shown in the lower figure in FIG. 13 may be obtained. It can be seen that as a ratio of the average missing time interval of contract processes to the average missing processing time of contract processes gradually decreases, the CPU utilization rate of the block chain node also gradually decreases.

Ideally, the number of resident contract processes corresponding to a “target optimal solution” is always expected to be used as the maximum number of contract processes supported by the docker, because in this case, the CPU utilization rate is the highest. However, it is difficult to achieve this CPU utilization rate in practice, because a future processing situation cannot be predicted. Based on this, in the solution of this embodiment, the number of resident contract processes corresponding to a “calculated optimal solution” is used as the maximum number of contract processes supported by the docker. The numerical value is the number of contract processes resident in the docker when the ratio of the average missing time interval of contract processes to the average missing processing time of contract processes is 1. It can be seen from FIG. 13 that, although there is a difference between this numerical value and the number of resident contract processes corresponding to the “calculated optimal solution”, the difference is generally small.

Therefore, in this embodiment, the number of resident contract processes in the docker is determined when the ratio of the average missing time interval of contract processes to the average missing processing time of contract processes is 1, and then the number of resident contract processes may be used as the maximum number of contract processes supported by the docker.

In some other embodiments, a ratio of the average missing time interval of contract processes to the average missing processing time of contract processes that is used when the maximum number of contract processes supported by the docker is determined may further be adjusted. For example, the ratio may be dynamically determined according to an actual dynamic detection situation. Therefore, in this embodiment, the ratio is not limited to 1. Generally, a ratio dynamically detected based on the actual scene does not differ significantly from 1.

Based on the method provided in this embodiment, according to an execution rule of smart contracts, a more proper maximum number of contract processes supported by the docker, i.e., the maximum number of resident contract processes contained in the resident contract process set, may be dynamically determined. Under the limit of the maximum number of contract processes, the CPU resource in the block chain node may be used most efficiently.

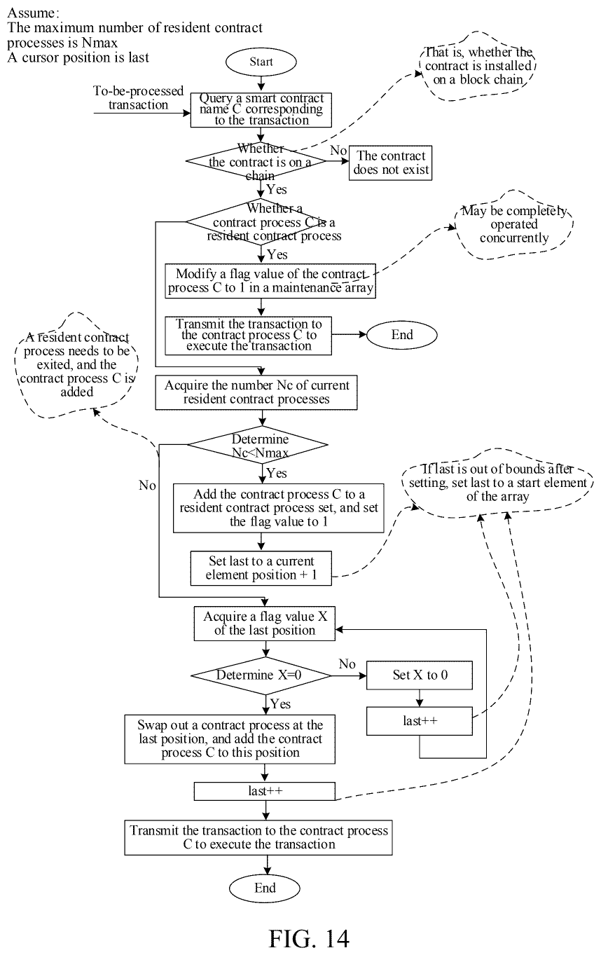

FIG. 14 is a flowchart of a block chain-based transaction processing method according to an exemplary application scene. As shown in FIG. 14, it is assumed that the maximum number of resident contract processes is represented as Nmax, and a cursor position in a maintenance array is represented as last.

After a to-be-processed transaction is acquired, a smart contract name corresponding to the transaction is queried, and it is assumed that the smart contract name is C.

Then, whether the contract is on a chain is determined, that is, whether the contract is installed on a block chain is determined.

If a determining result is no, the contract does not exist.

If the determining result is yes, it is further determined whether the contract process C is a resident contract process, that is, determining whether the contract process C is contained in the resident contract process set. The maintenance array records the resident contract process set and records flag values of resident contract processes.

If a determining result is yes, the flag value of the corresponding contract process C is modified to 1 in the maintenance array, and then the transaction is transmitted to the contract process C for processing. In this case, a processing procedure for the transaction ends.

If the determining result is no, the number Nc of current resident contract processes is acquired, and it is further determined whether Nc is less than Nmax.

If a determining result is yes, the number of resident contract processes in the resident contract process set does not reach the maximum number of contract processes supported by the docker. Therefore, the contract process C is directly added to the resident contract process set, a flag value of the contract process C is set to 1, and a last position in the maintenance array is set to a next element position of the contract process C, i.e., last+1.

If the determining result is no, a resident contract process needs to be exited from the resident contract process set so that the contract process C can be added to the resident contract process set. Therefore, a flag value X of the cursor position in the maintenance array is acquired, and it is further determined whether the flag value X of the cursor position is 0.

If a determining result is no, the flag value X of the cursor position is set to 0, the next element position is used as a new cursor position, i.e., last++. Then, the process of acquiring the flag value X of the cursor position in the current maintenance array and further determining whether the flag value X of the cursor position is 0 continues to be performed.

If the determining result is yes, the resident contract process at the cursor position is replaced with the contract process C, that is, the resident contract process at the cursor position is exited from the resident contract process set, and the contract process C is added to the resident contract process set. Then, the next element position is used as the new cursor position, i.e., last++, and then the transaction is transmitted to the contract process C for processing. In this case, a processing procedure for the transaction ends.

It can be seen from the foregoing that, in this embodiment, the smart contract in the block chain node is executed and maintained using the maintenance array. Since a data structure such as an array occupies a very small memory, the data structure is unlikely to span a plurality of memory pages, thereby reducing the performance loss caused by swapping out of memory page defaults. In addition, since this embodiment relates to an array operation, there is no operation contention, and different array elements may be operated in parallel, thereby further reducing the performance loss. Furthermore, since elements in the array may be completely operated concurrently, performance consumption in the block chain node can be saved, thereby improving the transaction processing performance in the block chain node.

Details of content of operations in the exemplary procedure shown in FIG. 14 are recorded in detail in the foregoing embodiments, and details are not described in this embodiment again. In addition, Nmax mentioned in the exemplary procedure shown in FIG. 14 may be dynamically acquired using the solution recorded in the foregoing embodiment, and a detailed acquiring process is not described herein again.

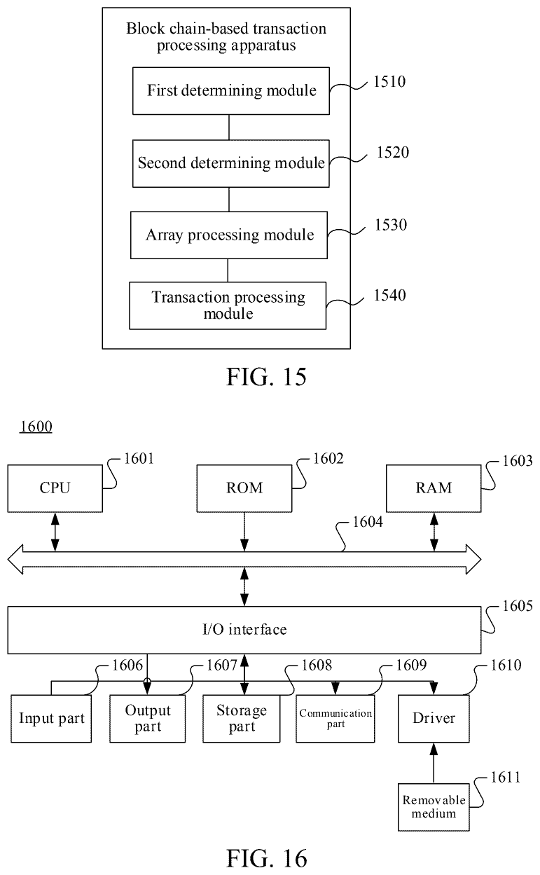

FIG. 15 is a block diagram of a block chain-based transaction processing apparatus according to an exemplary embodiment of the present disclosure. The apparatus may be configured on a block chain node. Specifically, the apparatus may be implemented as a functional module on a maintenance thread in a docker deployed in the block chain node. Certainly, the apparatus may alternatively be configured on another block chain node device that supports the docker as a virtual machine of a smart contract. This is not limited herein.

As shown in FIG. 15, the apparatus includes a first determining module 1510, a second determining module 1520, an array processing module 1530, and a transaction processing module 1540.

The first determining module 1510 is configured to determine a smart contract configured for processing a transaction. The second determining module 1520 is configured to determine a target resident contract process according to flag values corresponding to resident contract processes recorded in a maintenance array, each of the flag values indicating an execution state of a corresponding resident contract process, and the maximum number of resident contract processes recorded in the maintenance array being the maximum number of contract processes supported by a docker deployed in the block chain node. The array processing module 1530 is configured to replace, in the maintenance array, the target resident contract process with a target contract process corresponding to the smart contract and modify a target flag value corresponding to the target contract process to a first value, the first value characterizing that a corresponding contract process is in an executed state. The transaction processing module 1540 is configured to transmit the transaction to the target contract process for processing.

In another exemplary embodiment, the apparatus further includes a first determination module. The first determination module is configured to perform the following operations:
determining whether the target contract process is one of the resident contract processes;
performing, if the target contract process is not one of the resident contract processes, the operation of determining a target resident contract process according to flag values corresponding to resident contract processes recorded in a maintenance array; and
transmitting, if the target contract process is one of the resident contract processes, after the target flag value corresponding to the target contract process in the maintenance array is modified to the first value, the transaction to the target contract process for processing.

In another exemplary embodiment, the apparatus further includes a first acquisition module and a second determination module. The first acquisition module is configured to acquire the number of current resident contract processes in the docker. The second determination module is configured to perform the following operations:
performing, if the number of current resident contract processes in the docker is not less than the maximum number of contract processes supported by the docker, the operation of determining a target resident contract process according to flag values corresponding to resident contract processes recorded in a maintenance array;
using, if the number of current resident contract processes in the docker is less than the maximum number of contract processes supported by the docker, the target contract process as the resident contract process, and recording the target contract process in the maintenance array; and
modifying, in the maintenance array, the target flag value corresponding to the target contract process to the first value, and using a next element position of an element position where the target contract process is located as a cursor position, the cursor position characterizing an element position at which detection of the target resident contract process starts.

In another exemplary embodiment, the apparatus further includes a second acquisition module, a third determination module, and an update module. The second acquisition module is configured to acquire a flag value of a cursor position in the maintenance array. The update module is configured to determine, after the target flag value corresponding to the target contract process is modified to the first value, a next element position located in the target contract process in the maintenance array as a new cursor position. The third determination module is configured to perform the following operations:
determining, if the flag value of the cursor position is a second value, a resident contract process corresponding to the cursor position as the target resident contract process, the second value characterizing that a corresponding contract process is in a non-executed state; and
modifying, if the flag value of the cursor position is not the second value, the flag value of the cursor position to the second value, and determining a next element position of the cursor position as the new cursor position; and jumping to the operation of acquiring a flag value of a cursor position in the maintenance array.

In another exemplary embodiment, the apparatus further includes an out-of-bounds processing module configured to determine a start element position of the maintenance array as the cursor position in a case that the cursor position determined in the maintenance array is out of bounds.

In another exemplary embodiment, the apparatus further includes a number determining module configured to perform the following operations:
detecting an average missing time interval of contract processes and an average missing processing time of contract processes in the block chain node, where the average missing time interval of contract processes characterizes an average time interval between occurrences of missing of smart contract processes, and the average missing processing time of contract processes characterizes a time cycle of restarting a missing contract process; and
determining the maximum number of contract processes supported by the docker based on the average missing time interval of contract processes and the average missing processing time of contract processes.

In another exemplary embodiment, the number determining module is further configured to determine the number of resident contract processes in the docker when a ratio of the average missing time interval of contract processes to the average missing processing time of contract processes is 1; and use the number of resident contract processes as the maximum number of contract processes supported by the docker.

In another exemplary embodiment, the first determination module is further configured to:
query whether the smart contract is installed on the block chain node;
determine, if the smart contract is already installed on the block chain node,
whether the target contract process is one of the resident contract processes; and
perform, if the smart contract is not installed on the block chain node, prompt processing indicating that the contract does not exist.

In another exemplary embodiment, the first determination module is further configured to:
acquire a smart contract list corresponding to the block chain node, the smart contract list recording a contract name of a smart contract already installed on the block chain node; and
search the smart contract list for the contract name corresponding to the smart contract.

The apparatus provided by the foregoing embodiments has the same concept as the method provided by the foregoing embodiments, and the specific manner in which the modules and units perform operations has been described in detail in the method embodiments, and will not be described in detail herein. The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. In practical application, the apparatus provided by the foregoing embodiments may allocate the foregoing functions to different functional modules according to needs. That is, the internal structure of the apparatus may be divided into different functional modules to complete all or some of the functions described above. This is not limited herein.

Embodiments of the present disclosure further provide an electronic device, including: one or more processors; and a storage apparatus configured to store one or more programs, the one or more programs, when executed by the one or more processors, causing the electronic device to implement the block chain-based transaction processing method provided in the foregoing embodiments.

FIG. 16 is a schematic structural diagram of a computer system adapted to implement an electronic device according to an embodiment of the present disclosure. A computer system 1600 of the electronic device shown in FIG. 16 is merely an example and does not constitute any limitation on functions and use ranges of the embodiments of the present disclosure.

As shown in FIG. 16, the computer system includes a CPU 1601, which may perform various suitable actions and processing based on a program stored in a read-only memory (ROM) 1602 or a program loaded from a storage part 1608 into a random access memory (RAM) 1603, for example, perform the method described in the foregoing embodiments. The RAM 1603 further stores various programs and data required for system operations. The CPU 1601, the ROM 1602, and the RAM 1603 are connected to each other through a bus 1604. An input/output (I/O) interface 1605 is further connected to the bus 1604.

The following components are connected to the I/O interface 1605: an input part 1606 including a keyboard, a mouse, and the like; an output part 1607 including a cathode ray tube (CRT), a liquid crystal display (LCD), a speaker, and the like; the storage part 1608 including a hard disk and the like; and a communication part 1609 including a network interface card such as a local area network (LAN) card and a modem. The communication part 1609 performs communication processing via a network such as the Internet. A driver 1610 is further connected to the I/O interface 1605 according to needs. A removable medium 1611, such as a magnetic disk, an optical disc, a magneto-optical disk, and a semiconductor memory, is installed on the driver 1610 according to needs so that a computer program read from the removable medium is installed into the storage part 1608 according to needs.

Particularly, according to the embodiments of the present disclosure, the processes described in the following by referring to the flowcharts may be implemented as computer software programs. For example, the embodiments of the present disclosure include a computer program product. The computer program product includes a computer program stored in a computer-readable medium. The computer program includes a computer program configured for performing the method shown in the flowchart. In such an embodiment, the computer program may be downloaded and installed from a network through the communication part 1609, and/or installed from the removable medium 1611. When the computer program is executed by the CPU 1601, various functions defined in the system of the present disclosure are executed.

The computer-readable medium shown in the embodiments of the present disclosure may be a computer-readable signal medium, a computer-readable storage medium, or any combination of the two. For example, the computer-readable storage medium may be an electric, magnetic, optical, electromagnetic, infrared, or semi-conductive system, apparatus, or device, or any combination of thereof. A more specific example of the computer-readable storage medium may include but is not limited to: an electrical connection having one or more wires, a portable computer magnetic disk, a hard disk, a RAM, a ROM, an erasable programmable read only memory (EPROM), a flash memory, an optical fiber, a compact disk read-only memory (CD-ROM), an optical storage device, a magnetic storage device, or any appropriate combination thereof.

The flowcharts and block diagrams in the accompanying drawings illustrate possible system architectures, functions and operations that may be implemented by a system, a method, and a computer program product according to various embodiments of the present disclosure. Each box in a flowchart or a block diagram may represent a module, a program segment, or a part of code. The module, the program segment, or the part of code includes one or more executable instructions configured for implementing specified logic functions. In some implementations used as substitutes, functions annotated in boxes may alternatively occur in an order different from that annotated in the accompanying drawing. For example, actually two boxes shown in succession may be performed basically in parallel, and sometimes the two boxes may be performed in a reverse order. This is determined by a related function. Each box in a block diagram or a flowchart and a combination of boxes in the block diagram or the flowchart may be implemented using a dedicated hardware-based system configured to perform a specified function or operation, or may be implemented using a combination of dedicated hardware and a computer instruction.

A related unit described in the embodiments of the present disclosure may be implemented in a software manner, or may be implemented in a hardware manner, and the unit described may further be provided in a processor. Names of the units do not constitute a limitation on the units in a specific case.

According to another aspect of the present disclosure, a computer-readable storage medium is further provided, having a computer program stored therein. The computer program, when executed by a processor, implements the foregoing block chain-based transaction processing method. The computer-readable storage medium may be contained in the electronic device described in the foregoing embodiments, or may exist alone and is not assembled in the electronic device.

Embodiments of the present disclosure further provide a computer program product including a computer program which, when run on a computer, causes the computer to perform the method provided by the foregoing the embodiments.

The foregoing descriptions are merely preferred exemplary embodiments of the present disclosure and are not intended to limit the implementation solutions of the present disclosure. A person skilled in the art may make corresponding modifications and variations conveniently according to the main concept and spirit of the present disclosure. Therefore, the protection scope of the present disclosure is to be subject to the protection scope of the claims.

During application of the related data acquisition processing in the present disclosure, the informed consent or independent consent of the subject of personal information is to be obtained strictly according to requirements of laws and regulations of related nations, and subsequent data use and processing behaviors are performed within the laws and regulations and the authorization scope of the subject of personal information.

What is claimed is:

1. A block chain-based transaction processing method, performed by a block chain node, and comprising:
determining a smart contract configured for processing a transaction;
determining a target resident contract process according to flag values corresponding to resident contract processes recorded in a maintenance array, each of the flag values indicating an execution state of a corresponding resident contract process, and a maximum number of resident contract processes recorded in the maintenance array being a maximum number of contract processes supported by a docker deployed in the block chain node;
replacing, in the maintenance array, the target resident contract process with a target contract process corresponding to the smart contract, and modifying a target flag value corresponding to the target contract process to a first value, the first value characterizing that a corresponding contract process is in an executed state; and
transmitting the transaction to the target contract process for processing.

2. The method according to claim 1, further comprising:
determining whether the target contract process is one of the resident contract processes; and
performing, in response to that the target contract process is not one of the resident contract processes, the operation of determining the target resident contract process according to the flag values corresponding to the resident contract processes recorded in the maintenance array.

3. The method according to claim 2, further comprising:
transmitting, in response to that the target contract process is one of the resident contract processes, after the target flag value corresponding to the target contract process in the maintenance array is modified to the first value, the transaction to the target contract process for processing.

4. The method according to claim 1, further comprising:
acquiring a number of current resident contract processes in the docker; and
performing, in response to that the number of current resident contract processes in the docker is not less than the maximum number of contract processes supported by the docker, the operation of determining the target resident contract process according to the flag values corresponding to the resident contract processes recorded in the maintenance array.

5. The method according to claim 4, further comprising:
using, in response to that the number of current resident contract processes in the docker is less than the maximum number of contract processes supported by the docker, the target contract process as the resident contract process, and recording the target contract process in the maintenance array; and
modifying, in the maintenance array, the target flag value corresponding to the target contract process to the first value, and using a next element position of an element position where the target contract process is located as a cursor position, the cursor position characterizing an element position at which detection of the target resident contract process starts.

6. The method according to claim 1, wherein the determining a target resident contract process according to flag values corresponding to resident contract processes recorded in a maintenance array comprises:
acquiring a flag value of a cursor position in the maintenance array, the cursor position characterizing an element position in the maintenance array at which detection of the target resident contract process starts; and
determining, in response to that the flag value of the cursor position is a second value, a resident contract process corresponding to the cursor position as the target resident contract process, the second value characterizing that a corresponding contract process is in a non-executed state; and
the method further comprises:
determining, after the target flag value corresponding to the target contract process is modified to the first value, a next element position located in the target contract process in the maintenance array as a new cursor position.

7. The method according to claim 6, further comprising:
modifying, in response to that the flag value of the cursor position is not the second value, the flag value of the cursor position to the second value, and determining a next element position of the cursor position as the new cursor position; and
jumping to the operation of acquiring the flag value of the cursor position in the maintenance array.

8. The method according to claim 5, further comprising:
determining a start element position of the maintenance array as the cursor position in response to that the cursor position determined in the maintenance array is out of bounds.

9. The method according to claim 1, further comprising:
detecting an average missing time interval of contract processes and an average missing processing time of contract processes in the block chain node, wherein the average missing time interval of the contract processes characterizes an average time interval between occurrences of missing of smart contract processes in the block chain node, and the average missing processing time of the contract processes characterizes a time cycle of restarting a missing contract process in the block chain node; and
determining the maximum number of contract processes supported by the docker based on the average missing time interval of contract processes and the average missing processing time of contract processes.

10. The method according to claim 9, wherein the determining the maximum number of contract processes supported by the docker based on the average missing time interval of contract processes and the average missing processing time of contract processes comprises:
determining a number of resident contract processes in the docker when a ratio of the average missing time interval of contract processes to the average missing processing time of contract processes is 1; and
using the number of resident contract processes as the maximum number of contract processes supported by the docker.

11. The method according to claim 1, further comprising:
querying whether the smart contract is installed on the block chain node;
determining, in response to that the smart contract is already installed on the block chain node, whether the target contract process is one of the resident contract processes; and
performing, in response to that the smart contract is not installed on the block chain node, prompt processing indicating that the contract does not exist.

12. The method according to claim 11, wherein the querying whether the smart contract is installed on the block chain node comprises:
acquiring a smart contract list corresponding to the block chain node, the smart contract list recording a contract name of a smart contract already installed on the block chain node; and
searching the smart contract list for the contract name corresponding to the smart contract.

13. A block chain-based transaction processing apparatus for a block chain node, comprising:
one or more processors; and
a storage medium configured to store one or more computer programs, the one or more computer programs, when executed by the one or more processors, causing the one or more processors to implement:
determining a smart contract configured for processing a transaction;
determining a target resident contract process according to flag values corresponding to resident contract processes recorded in a maintenance array, each of the flag values indicating an execution state of a corresponding resident contract process, and a maximum number of resident contract processes recorded in the maintenance array being a maximum number of contract processes supported by a docker deployed in the block chain node;
replacing, in the maintenance array, the target resident contract process with a target contract process corresponding to the smart contract, and modifying a target flag value corresponding to the target contract process to a first value, the first value characterizing that a corresponding contract process is in an executed state; and
transmitting the transaction to the target contract process for processing.

14. The apparatus according to claim 13, wherein the one or more processors are further configured to implement:
determining whether the target contract process is one of the resident contract processes; and
performing, in response to that the target contract process is not one of the resident contract processes, the operation of determining the target resident contract process according to the flag values corresponding to the resident contract processes recorded in the maintenance array.

15. The apparatus according to claim 14, wherein the one or more processors are further configured to implement:
transmitting, in response to that the target contract process is one of the resident contract processes, after the target flag value corresponding to the target contract process in the maintenance array is modified to the first value, the transaction to the target contract process for processing.

16. The apparatus according to claim 13, wherein the one or more processors are further configured to implement:
acquiring a number of current resident contract processes in the docker; and
performing, in response to that the number of current resident contract processes in the docker is not less than the maximum number of contract processes supported by the docker, the operation of determining the target resident contract process according to the flag values corresponding to the resident contract processes recorded in the maintenance array.

17. The apparatus according to claim 16, wherein the one or more processors are further configured to implement:
using, in response to that the number of current resident contract processes in the docker is less than the maximum number of contract processes supported by the docker, the target contract process as the resident contract process, and recording the target contract process in the maintenance array; and
modifying, in the maintenance array, the target flag value corresponding to the target contract process to the first value, and using a next element position of an element position where the target contract process is located as a cursor position, the cursor position characterizing an element position at which detection of the target resident contract process starts.

18. The apparatus according to claim 12, wherein the determining a target resident contract process according to flag values corresponding to resident contract processes recorded in a maintenance array comprises:
acquiring a flag value of a cursor position in the maintenance array, the cursor position characterizing an element position in the maintenance array at which detection of the target resident contract process starts; and
determining, in response to that the flag value of the cursor position is a second value, a resident contract process corresponding to the cursor position as the target resident contract process, the second value characterizing that a corresponding contract process is in a non-executed state; and
the one or more processors are further configured to implement:
determining, after the target flag value corresponding to the target contract process is modified to the first value, a next element position located in the target contract process in the maintenance array as a new cursor position.

19. The apparatus according to claim 18, wherein the one or more processors are further configured to implement:
modifying, in response to that the flag value of the cursor position is not the second value, the flag value of the cursor position to the second value, and determining a next element position of the cursor position as the new cursor position; and
jumping to the operation of acquiring the flag value of the cursor position in the maintenance array.

20. A non-transitory computer-readable storage medium, having computer-readable instructions stored therein, and the computer-readable instructions, when executed by a processor of a block chain node, causing the processor to perform:
determining a smart contract configured for processing a transaction;
determining a target resident contract process according to flag values corresponding to resident contract processes recorded in a maintenance array, each of the flag values indicating an execution state of a corresponding resident contract process, and a maximum number of resident contract processes recorded in the maintenance array being a maximum number of contract processes supported by a docker deployed in the block chain node;
replacing, in the maintenance array, the target resident contract process with a target contract process corresponding to the smart contract, and modifying a target flag value corresponding to the target contract process to a first value, the first value characterizing that a corresponding contract process is in an executed state; and
transmitting the transaction to the target contract process for processing.
